(19) United States
(12) Patent Application Publication
(10) Pub. No.: US 2026/0091766 A1
(43) Pub. Date: Apr. 2, 2026

(54) Integrated Vehicle Jack System

(71) Applicants: Hagan Halfmann, Garden City, TX (US); Tana Halfmann, Garden City, TX (US); Scott Halfmann, Garden City, TX (US)

(72) Inventors: Hagan Halfmann, Garden City, TX (US); Tana Halfmann, Garden City, TX (US); Scott Halfmann, Garden City, TX (US)

(21) Appl. No.: 19/344,869

(22) Filed: Sep. 30, 2025

Related U.S. Application Data
(60) Provisional application No. 63/702,313, filed on Oct. 2, 2024.

(51) Int. Cl. B60S 9/10; B60S 9/06; G01C 9/06; G06F 3/0484; G06F 3/0488; G07C 5/08

(52) U.S. Cl. CPC B60S 9/10; B60S 9/06; G01C 9/06; G07C 5/0825; G07C 5/0833; G06F 3/0484; G06F 3/0488

(57) ABSTRACT

An integrated vehicle jack system is provided. The system is comprised of at least one automated jack integrated into the vehicle's undercarriage, with the preferred embodiment incorporating four jacks positioned near each wheel to evenly support and lift the vehicle. The jacks are capable of supporting up to three tons each, allowing the system to lift vehicles of various sizes, including SUVs and light trucks. A touchscreen interface located inside the vehicle or integrated into its infotainment system provides users with a visual representation of the jack positions and interactive controls for selecting lift modes, such as full lift, side lift, or corner lift. Additionally, the system can be controlled via a wireless remote that includes backlit buttons, a speaker for alerts, and an emergency retract function.

### CROSS-REFERENCE TO RELATED APPLICATION

The present application claims priority to, and the benefit of, U.S. Provisional Application No. 63/702,313, which was filed on Oct. 2, 2024, and is incorporated herein by reference in its entirety.

### FIELD OF THE INVENTION

The present invention relates generally to the field of vehicle jacks. More specifically, the present invention relates to an automated jack integrated into the vehicle's undercarriage, with the preferred embodiment incorporating four jacks positioned near each wheel to evenly support and lift the vehicle. Accordingly, the present disclosure makes specific reference thereto. Nonetheless, it is to be appreciated that aspects of the present invention are also equally applicable to other like applications, devices, and methods of manufacture.

### BACKGROUND

Drivers frequently encounter the inconvenience of flat tires and may find themselves stranded without a jack readily available in their vehicle. This situation can lead to significant expenses related to towing services, as well as increased stress and potential delays. The traditional manual jack, commonly stored in a vehicle's trunk, requires physical strength and precision to operate effectively. Many drivers, particularly those without mechanical experience, find it challenging to position and operate a jack correctly. Improper deployment can lead to the vehicle shifting or falling during a repair, posing a serious safety hazard. Additionally, the process of manually lifting a vehicle can be time-consuming and physically demanding, further discouraging routine maintenance tasks such as tire rotations or undercarriage inspections. To address these challenges, an improved solution is necessary to ensure convenience, safety, and reliability during vehicle lifting operations.

Therefore, there exists a long-felt need in the art for an automated vehicle jack system that eliminates the need for manual jacks by providing an integrated, user-friendly lifting mechanism within the vehicle's structure. There also exists a long-felt need in the art for an automated vehicle jack system that allows drivers to lift the vehicle safely and precisely through a centralized control interface, reducing the risk of improper deployment or imbalance. Moreover, there exists a long-felt need in the art for an automated vehicle jack system that includes safety features such as gyroscopic and load sensors to monitor surface stability and prevent accidents during the lifting process.

The subject matter disclosed and claimed herein, in one embodiment thereof, comprises an integrated vehicle jack system. The system is comprised of at least one automated jack integrated into the vehicle's undercarriage, with the preferred embodiment incorporating four jacks positioned near each wheel to evenly support and lift the vehicle. The jacks are capable of supporting up to three tons each, allowing the system to lift vehicles of various sizes, including SUVs and light trucks. A touchscreen interface located inside the vehicle or integrated into its infotainment system provides users with a visual representation of the jack positions and interactive controls for selecting lift modes, such as full lift, side lift, or corner lift. Additionally, the system can be controlled via a wireless remote that includes backlit buttons, a speaker for alerts, and an emergency retract function. Safety is further ensured through gyroscopic and accelerometer sensors that monitor the vehicle's tilt and load sensors that prevent overloading. If uneven surfaces or excessive loads are detected, the system halts the lifting process and issues a warning.

In this manner, the integrated vehicle jack system of the present invention accomplishes all the foregoing objectives by providing an integrated set of automated jacks installed in a vehicle's undercarriage, controlled via an in-cabin touchscreen interface and/or a wireless remote control. The system enables users to lift the entire vehicle or specific sections through intuitive dashboard controls, supporting various maintenance tasks. The inclusion of gyroscopic and accelerometer sensors ensures that the vehicle remains stable, automatically compensating for surface irregularities. The load sensors prevent excessive stress on individual jacks, while an emergency retract feature provides an added layer of safety. By automating the lifting process and enhancing safety protocols, the system significantly improves the convenience and security of vehicle maintenance and emergency repairs.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an integrated vehicle jack system. The present invention pertains to an automated vehicle jack system designed to enhance safety and convenience during vehicle lifting for flat tire changes or routine maintenance. The system comprises at least one automated jack mounted in the vehicle undercarriage, eliminating the need for manual jacks.

In a preferred embodiment, four individual jacks are positioned near each wheel area, with options for electro-hydraulic, motorized scissor, or other suitable jack types. Each jack can support between one to three tons, allowing the system to lift vehicles with a combined weight capacity exceeding eight tons. Alternative configurations accommodate heavy-duty vehicles and provide enhanced load distribution.

The system includes a touchscreen interface mounted in the vehicle's interior, which may be integrated into the infotainment system. The interface displays a visual layout with interactive icons for controlling the lifting and lowering of individual or multiple jacks. Real-time feedback indicates jack status, such as deployment progress, completion, or malfunctions. An emergency retract button allows immediate lowering in case of an emergency.

A wireless remote control provides additional convenience, featuring buttons for lifting modes such as full lift, side lift, and corner lift. The remote also includes an emergency retract button and backlit controls, with an integrated speaker that emits audible alerts for completed commands or errors.

The system incorporates gyroscopic and accelerometer sensors to monitor the vehicle's tilt and adjust jack extensions to maintain a level lift. If surface inclination exceeds a predefined threshold, the system prevents deployment and issues warnings. Load sensors on each jack ensure the applied load remains within safe limits, halting the lifting process if exceeded.

Multiple lifting modes accommodate various maintenance tasks. Full lift mode raises the entire vehicle, side lift mode tilts the vehicle laterally, and corner lift mode raises one corner for tire changes or brake inspections. The system is powered by the vehicle's electrical system and designed for efficient energy use, minimizing battery drain.

The system's method of use includes selecting the desired lifting mode via the touchscreen interface or remote control, with real-time feedback provided throughout the process. Safety sensors continuously monitor for unstable conditions and halt the operation when necessary. After maintenance, the user can retract the jacks via the interface or emergency retract button.

The automated vehicle jack system offers significant advantages over manual jacks, including reduced effort, improved safety, and multi-purpose functionality for various maintenance tasks, making it a practical and integrated solution for vehicle owners.

Accordingly, the integrated vehicle jack system of the present invention is particularly advantageous as it provides an integrated set of automated jacks installed in a vehicle's undercarriage, controlled via an in-cabin touchscreen interface and/or a wireless remote control. The system enables users to lift the entire vehicle or specific sections through intuitive dashboard controls, supporting various maintenance tasks. The inclusion of gyroscopic and accelerometer sensors ensures that the vehicle remains stable, automatically compensating for surface irregularities. The load sensors prevent excessive stress on individual jacks, while an emergency retract feature provides an added layer of safety. By automating the lifting process and enhancing safety protocols, the system significantly improves the convenience and security of vehicle maintenance and emergency repairs. In this manner, the integrated vehicle jack system overcomes the limitations of existing methods of jacking vehicles known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an integrated vehicle jack system of the present invention in accordance with the disclosed architecture;

FIG. 2 illustrates a perspective view of a touchscreen interface of one potential embodiment of an integrated vehicle jack system of the present invention in accordance with the disclosed architecture; and

FIG. 3 illustrates a flowchart of a method of using one potential embodiment of an integrated vehicle jack system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an automated vehicle jack system that eliminates the need for manual jacks by providing an integrated, user-friendly lifting mechanism within the vehicle's structure. There also exists a long-felt need in the art for an automated vehicle jack system that allows drivers to lift the vehicle safely and precisely through a centralized control interface, reducing the risk of improper deployment or imbalance. Moreover, there exists a long-felt need in the art for an automated vehicle jack system that includes safety features such as gyroscopic and load sensors to monitor surface stability and prevent accidents during the lifting process.

The present invention, in one exemplary embodiment, is comprised of an integrated vehicle jack system. The present invention relates to an automated vehicle jack system designed to improve safety and convenience during vehicle lifting for tire changes or routine maintenance. The system comprises at least one automated jack installed in the vehicle's undercarriage, eliminating the need for manual jacks.

In a preferred embodiment, four jacks are positioned near each wheel, with options for electro-hydraulic, motorized scissor, or other suitable jack types. Each jack supports between one to three tons, enabling the system to lift vehicles with a combined weight capacity exceeding eight tons. Alternative configurations accommodate heavy-duty vehicles and improve load distribution.

The system features a touchscreen interface installed in the vehicle's interior, optionally integrated into the infotainment system. The interface presents a visual layout with interactive icons for controlling the lifting and lowering of individual or multiple jacks. Real-time feedback indicates jack status, such as deployment progress, completion, or malfunctions. An emergency retract button enables immediate lowering in case of emergencies.

A wireless remote control enhances convenience with buttons for lifting modes, including full lift, side lift, and corner lift. The remote also includes an emergency retract button and backlit controls, along with a speaker that emits alerts for completed commands or errors.

The system incorporates gyroscopic and accelerometer sensors to monitor the vehicle's tilt and adjust jack extensions to ensure a level lift. If the surface incline exceeds a safety threshold, the system prevents deployment and issues a warning. Load sensors on each jack monitor the applied load and halt the lifting process if the safe limit is exceeded.

The system supports multiple lifting modes for different maintenance tasks. Full lift mode raises the entire vehicle, side lift mode tilts it laterally, and corner lift mode raises one corner for tasks such as tire changes or brake inspections. Powered by the vehicle's electrical system, the system is designed for efficient energy consumption, minimizing battery drain.

The method of operation involves selecting the desired lifting mode via the touchscreen interface or remote control, with real-time feedback provided throughout the process. Safety sensors monitor for unstable conditions, halting the operation when necessary. After maintenance, the user can lower the jacks using the interface or emergency retract button.

The automated vehicle jack system provides advantages over manual jacks, such as reduced effort, enhanced safety, and versatility for various maintenance tasks. The integration of automated jacks controlled through an in-cabin interface or remote control simplifies the lifting process. Sensors ensure stability by compensating for surface irregularities, while load monitoring and an emergency retract function provide additional safety. This system significantly enhances the convenience and safety of vehicle maintenance and emergency repairs, addressing the limitations of traditional vehicle jacking methods.

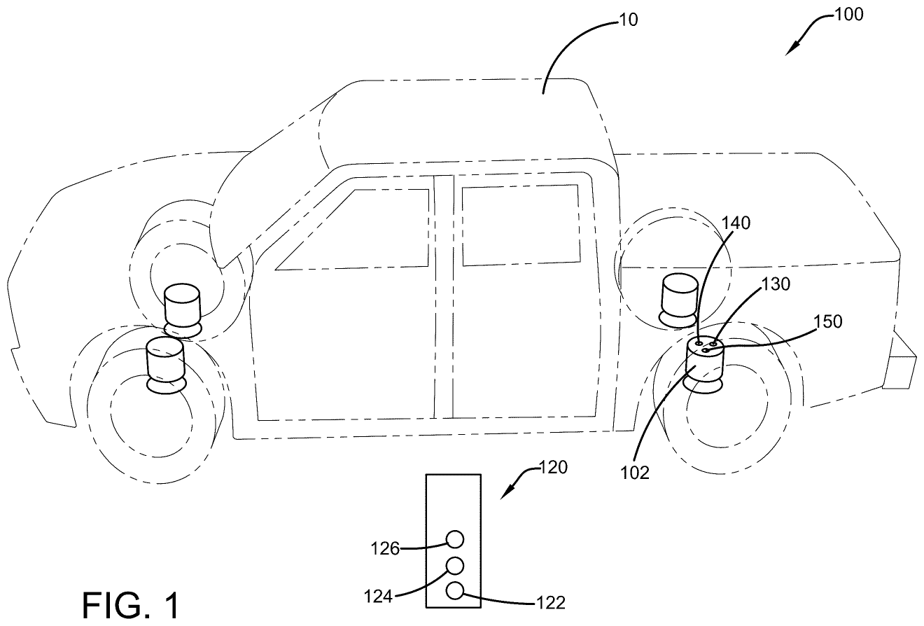

Referring initially to the drawings, FIG. 1 illustrates a perspective view of one potential embodiment of an integrated vehicle jack system 100 of the present invention in accordance with the disclosed architecture. The present invention relates to an automated vehicle jack system 100 designed to address common challenges faced by drivers when dealing with flat tires or routine maintenance. More specifically, the system 100 is comprised of at least one fully automated jack 102 mounted into the undercarriage of a vehicle 10. This eliminates the need for manual jacks and significantly improves convenience and safety.

In the preferred embodiment, the system 100 includes four individual jacks 102, each jack 102 positioned near a corresponding wheel area of a vehicle 10, as seen in FIG. 1. The jack 102 may be comprised of an electro-hydraulic actuator jack, a motorized scissor-style jack, or other suitable jack type or mechanism capable of reliable and smooth operation. Each jack 102 is designed to support between one and three tons, ensuring compatibility with a wide range of vehicles, including sedans, SUVs, and light-duty trucks. As a result, the system 100 as a whole is capable of lifting the entire vehicle with a combined weight capacity exceeding eight tons. In alternative embodiments, the system 100 may include larger or stronger jacks 102 to accommodate heavy-duty vehicles, as well as additional jacks 102 to provide enhanced load distribution for larger or longer vehicles.

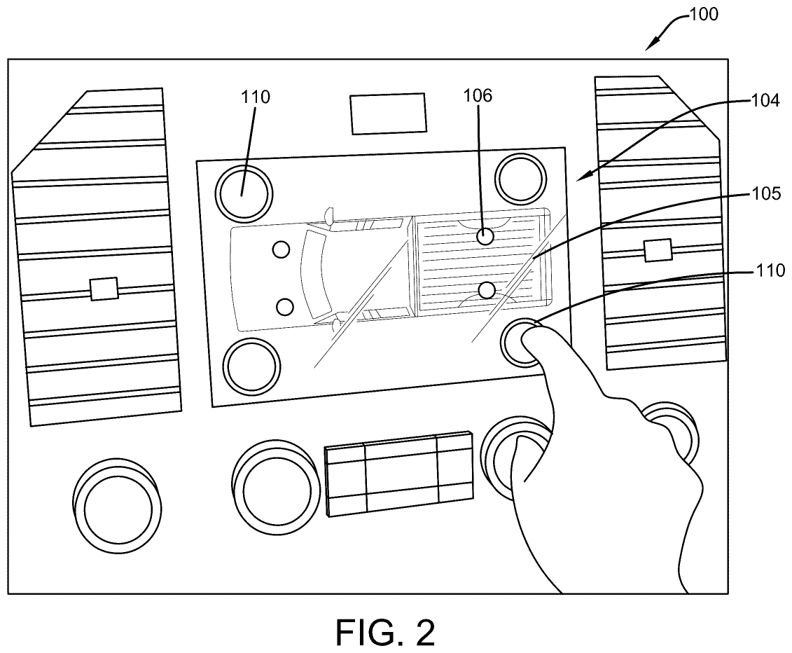

In one embodiment, the jacks 102 are individually controlled via a touchscreen interface 104 that can be mounted in the interior of the vehicle 10, as seen in FIG. 2. In certain embodiments, the interface 104 may be integrated into the native infotainment system of the vehicle. The interface 104 displays a visual layout 105 of the vehicle, highlighting the locations of each jack 102. Interactive icons 106 corresponding to each jack 102 allow the user to control the lifting and lowering process by selecting individual or multiple jacks 102 to raise or lower. The interface 104 provides real-time feedback on the status of the jacks 102, helping users monitor the progress of the lift. For example, an icon 106 of a first color signifies that a jack 102 is fully deployed, while an icon 106 of a second color denotes that deployment of the jack 102 is in progress. An icon 106 of a third color warns of an error or malfunction, such as a misaligned lift or a surface instability. A digital emergency retract button 110 is also included in the interface 104 to allow the user to quickly lower all jacks 102 in case of an emergency or unexpected situation.

In addition to the dashboard interface 104, the system 100 may include a remote control 120 (as seen in FIG. 1) that connects to the jacks 102 wirelessly via Bluetooth or Wi-Fi, enabling users to operate the jacks 102 remotely. This feature provides added convenience by allowing the user to lift or lower the vehicle 10 without needing to be inside it, which can be advantageous when inspecting the vehicle's 10 position or during remote assistance. The remote 120 may be comprised of a plurality of buttons 122 that correspond to different lifting modes, including a full lift mode to raise all four jacks 102 simultaneously, a side-lift mode to lift only one side of the vehicle 10, and a corner-lift mode to lift only one wheel or one side diagonally (for example, the front right wheel and rear left wheel). The remote 120 also includes an emergency retract button 124 for added safety, allowing for immediate lowering of all jacks 102 in case of instability or user input error. For ease of use in low-light conditions, the buttons 122 may be backlit buttons and an integrated speaker 126 may emit an audible alert when a command is executed or when an error is detected.

The system 100 is also comprised of at least one gyroscopic sensor 130 and at least one accelerometer sensor 140 that continuously monitors the tilt angle of the vehicle 10 to ensure safe operation. If the sensors 130 and 140 detect that the vehicle 10 is on an uneven surface, the system 100 can adjust the extension of each jack 102 individually to maintain a level lift. The adjustment may involve shortening or extending specific jacks 102 to compensate for surface variations. If the incline of the surface exceeds a predefined safety threshold, the system 100 will prevent jack 102 deployment and issue a warning to the user via the interface 104 and/or a warning sound emitted by the speaker 126 on the remote 120. Each jack 102 is also fitted with load sensors 150 that measure the weight applied to the jack 102 and ensure it does not exceed the safe lifting limit. In cases where the detected load surpasses the system's 100 rated capacity, the system 100 will automatically halt the lifting process and alert the user to reduce the load or reposition the vehicle 10 to ensure stability.

As noted, the system 100 supports multiple maintenance modes to accommodate various service tasks. The full lift mode activates all four jacks 102 simultaneously, raising the entire vehicle for tasks such as oil changes or underbody inspections. The side-lift mode raises the jacks 102 on one side of the vehicle, tilting the vehicle laterally to facilitate tire rotations or suspension work. The system 100 also includes a corner-lift mode, which activates a single jack 102 to raise one corner of the vehicle for tire changes or brake inspections.

The system 100 is primarily powered by the vehicle's electrical system, drawing energy from the 12-volt or 24-volt battery, depending on the type of vehicle. The system 100 is designed with optimized power consumption to minimize the impact on the vehicle's primary functions, such as lighting and dashboard electronics. The electrical system powering the jacks 102 is designed to operate efficiently, ensuring that the system 100 can lift and lower the vehicle multiple times without significantly draining the vehicle's battery.

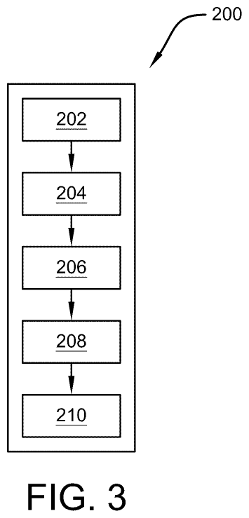

The present invention is also comprised of a method of using 200 the automated vehicle jack system 100, as seen in FIG. 3. First, an automated vehicle jack system 100 is provided, the system 100 is comprised of at least one automated jack 102, a touchscreen interface 104, and a remote control 120 [Step 202]. Then, the user accesses the touchscreen interface 104 or uses the remote control 120 to select the desired lifting mode, including full lift mode, side-lift mode, or corner-lift mode, by interacting with the corresponding interactive icons 106 or buttons 122 [Step 206]. Subsequently, the system 100 deploys the selected jacks 102, and the lifting process is initiated while real-time feedback is provided and monitored through the interface 104 and/or the speaker 126 [Step 208]. The system's 100 gyroscopic sensor 130, accelerometer sensor 140, and load sensors 150 continuously monitor the tilt angle and load distribution to ensure safe operation. If an unsafe condition is detected, such as surface instability or excessive load, the system 100 halts the lifting process and issues a warning to the user. Finally, after completing the maintenance task, the user can retract all jacks 102 by selecting the retract option on the touchscreen interface 104 or pressing the emergency retract button 124 on the remote control 120, ensuring the vehicle 10 is lowered safely and securely [Step 210].

The system 100 offers numerous advantages over traditional manual jacks. It significantly reduces the time and effort required to lift a vehicle, making it an ideal solution for emergencies and routine maintenance. Since the system 100 is permanently integrated into the vehicle, users no longer need to worry about carrying or losing a separate jack. The automated operation, touchscreen interface, remote control functionality, and built-in safety features reduce the risk of vehicle collapse and injury, providing a more secure lifting experience. Additionally, the system's 100 multi-purpose functionality supports a wide range of maintenance tasks, from tire changes to underbody inspections, making it a valuable addition to any vehicle.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “integrated vehicle jack system” and “system” are interchangeable and refer to the integrated vehicle jack system 100 of the present invention.

Notwithstanding the foregoing, the integrated vehicle jack system 100 of the present invention and its various components can be of any suitable size and configuration as is known in the art without affecting the overall concept of the invention, provided that they accomplish the above-stated objectives. One of ordinary skill in the art will appreciate that the size, configuration, and material of the integrated vehicle jack system 100 as shown in the FIGS. are for illustrative purposes only, and that many other sizes and shapes of the integrated vehicle jack system 100 are well within the scope of the present disclosure. Although the dimensions of the integrated vehicle jack system 100 are important design parameters for user convenience, the integrated vehicle jack system 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An integrated vehicle jack system comprising:
an automated jack mounted to an undercarriage of a vehicle, the automated jack configured to lift a portion of the vehicle;
a touchscreen interface configured to control the automated jack, the touchscreen interface displaying a visual layout of the vehicle and an interactive icon corresponding to the automated jack to facilitate the selection and the control of the automated jack;
a remote control comprising a plurality of buttons corresponding to different a lifting mode and an emergency retract button; and
a gyroscopic sensor and an accelerometer sensor configured to monitor a tilt angle of the vehicle and adjust the extension of the automated jacks based on a detected surface variation.

2. The integrated vehicle jack system of claim 1, wherein the automated jack is comprised of an electro-hydraulic jack.

3. The integrated vehicle jack system of claim 1, wherein the plurality of buttons are comprised of backlit buttons.

4. The integrated vehicle jack system of claim 1, wherein the remote control is in wireless electrical communication with the automated jack.

5. The integrated vehicle jack system of claim 1, wherein the remote is comprised of a speaker.

6. The integrated vehicle jack system of claim 4, wherein the speaker emits an audible alert upon execution of a command or a detection of an error.

7. The integrated vehicle jack system of claim 1, wherein the touchscreen interface provides a visual status update for the automated jack, including a first color indicating a full deployment, a second color indicating an in-progress deployment, and a third color indicating an error or a malfunction.

8. The integrated vehicle jack system of claim 1, wherein the gyroscopic sensor and the accelerometer sensor prevent deployment of the automated jack when the vehicle is on a surface with an incline exceeding a predefined safety threshold.

9. An integrated vehicle jack system comprising:
an automated jack mounted to an undercarriage of a vehicle, the automated jack configured to lift a portion of the vehicle;
a touchscreen interface configured to control the automated jack, the touchscreen interface displaying a visual layout of the vehicle and an interactive icon corresponding to the automated jack to facilitate the selection and the control of the automated jack;
a remote control comprising a plurality of buttons corresponding to different a lifting mode and an emergency retract button;
a load sensor configured to measure a weight applied to the automated jack and halt the lifting process of the vehicle if the weight exceeds a predefined limit; and
a gyroscopic sensor and an accelerometer sensor configured to monitor a tilt angle of the vehicle and adjust the extension of the automated jacks based on a detected surface variation.

10. The integrated vehicle jack system of claim 8, wherein the automated jack is comprised of a motorized scissor jack.

11. The integrated vehicle jack system of claim 8, wherein the emergency retract button automatically lowers the automated jack.

12. The integrated vehicle jack system of claim 8, wherein the automated jack has a weight limit between one and three tons.

13. The integrated vehicle jack system of claim 8, wherein the remote is comprised of a speaker.

14. The integrated vehicle jack system of claim 13, wherein the speaker emits an audible alert upon execution of a command or a detection of an error.

15. The integrated vehicle jack system of claim 8, wherein the touchscreen interface provides a visual status update for the automated jack, including a first color indicating a full deployment, a second color indicating an in-progress deployment, and a third color indicating an error or a malfunction.

16. The integrated vehicle jack system of claim 8, wherein the gyroscopic sensor and the accelerometer sensor prevent deployment of the automated jack when the vehicle is on a surface with an incline exceeding a predefined safety threshold.

17. The integrated vehicle jack system of claim 8, wherein the remote control is in wireless electrical communication with the automated jack.

18. A method of using an integrated vehicle jack system, the method comprising the following steps:
providing an integrated vehicle jack system comprised of a plurality of automated jacks mounted to an undercarriage of a vehicle, a touchscreen interface configured to control the plurality of automated jacks, and a remote control;
selecting a lifting mode of the plurality of automated jacks using the touchscreen interface or the remote control;
deploying the plurality of automated jacks based on the selected lifting mode and initiating a lifting process of the vehicle;
monitoring a tilt angle of the vehicle and a load distribution using a gyroscopic sensor, an accelerometer sensor, and a load sensor of the integrated vehicle jack system; and
retracting the plurality of automated jacks by selecting a retract option on the touchscreen interface or by pressing an emergency retract button on the remote control.

19. The method of using an integrated vehicle jack system of claim 18, wherein the lifting mode is comprised of a full lift mode, a side-lift mode, and a corner-lift mode.

20. The method of using an integrated vehicle jack system of claim 18, wherein the touchscreen interface is comprised of a visual indicator.
